(19) United States
(12) Patent Application Publication
(10) Pub. No.: US 2014/0137695 A1
(43) Pub. Date: May 22, 2014

(54) Electrical Heating System Using Designated Areas Like Footrests, Accelerator Pedals and Floor Areas for Directed Heat

(71) Applicant: Steven L. Permut, Huntington Woods, MI (US)

(72) Inventor: Steven L. Permut, Huntington Woods, MI (US)

(21) Appl. No.: 13/682,074

(22) Filed: Nov. 20, 2012

(51) Int. Cl. B60H 1/22; B60N 3/06

(52) U.S. Cl. CPC B60H 1/2215; B60N 3/06
USPC 74/513; 219/202; 296/75

(57) ABSTRACT

An electrically powered heating system for a vehicle includes one of a footrest or accelerator pedal in a footwell of a vehicle having a structural substrate and an upper surface constructed for engagement with a driver's foot. A heating element that is electrically powered is embedded in the footrest and/or accelerator pedal between the upper surface and the substrate for heating the foot.

### TECHNICAL FIELD

The field of this invention relates to an efficient heating system for a vehicle and more particularly an electric vehicle.

### BACKGROUND OF THE DISCLOSURE

Heating systems for an interior of an electric vehicle pose particular problems that do not exist for vehicles run on internal combustion engines. Internal combustion engines produce vast quantities of heat as a waste product. Large radiators are used to dissipate much of the heat to the ambient atmosphere away from the engine. In winter, it is not much of problem to redirect some of the heated coolant that normally goes to the radiator to a heater core and have a fan blow air through the core to transfer the heat to the flowing air and fill the entire interior cabin of the vehicle with this warmed air. There are ducts that direct the heated air to various areas of the interior cabin, for example to the footwells to warm the feet, to the front vents in the instrument panel to heat the occupants hands and head and upper body, as well as to the front windshield and side windows for defrosting and demisting the windows for better vision. Some vehicles even duct the heated air to the back seats for providing more comfort to the back seat occupants.

While a heater core provides sufficient heat from an internal combustion engine, the heat is not available until the engine is sufficiently warmed up, which in certain cold winter days may take ten or more minutes. For diesel engines, the time may be even longer. To provide faster heat, some vehicles, particularly ones with diesel engines, are provided with electric ceramic heaters which heat up very quickly and provide heat blown by a fan into the interior cabin. Furthermore, many vehicles are now equipped with electric heated seats which provide warmth within a few minutes. Some luxury vehicles are also provided with electrically heated steering wheels to warm the hands. Some front windshields and rear windows have also been provided with electric defrosters to clear the windows faster.

The abundance of heat as a waste product from an engine does not exist for electric powered vehicles. Electric powered motors do not produce much heat as a waste product. There is not enough heat produced as a waste product to heat the entire cabin or even the footwell of a cabin. Heat must be purposefully created to warm a vehicle occupant. This produced heat is a commodity that drains the battery of the electric vehicle and can greatly decrease the electric mileage range of the battery. As such, heat production to heat the entire vehicle cabin is restricted in order not to overly drain the battery and overly reduce the electric mileage range per charge.

Blowing air around the cabin including the footwell is not an efficient way to warm occupants because most of the heated air inside the cabin is remote from the occupant and thus has no heating effect on the occupant. The moving air also has an undesirable evaporative cooling effect on the human body that is contrary to the desired goal of making an occupant feel warmth. When people get cold, the feet are often perceived as the coldest parts of the body. Conversely, when one's feet are cold, one will not perceive themselves as warm. Inadequate heating to the lower part of the vehicle cabin may be tolerable during short trips but longer durations of having cold feet are intolerable.

The central heat system of most vehicles including electric vehicles directs heated air downwardly from above the floor. While this system that pushes warmed air from above may be adequate when massive amounts of heat are available from a heater core, it is not the most efficient way of heating. Extra energy is used to push the warm air downwardly against natural inclination of the warm air to rise. Furthermore, the floor of the vehicle is often made of steel or other metal which efficiently conducts the cold from a cold ambient exterior atmosphere i.e. the floor is chilled from the outside. Although insulation layers may often be layered on the floor and carpet also provided, the chill often permeates through the layers from the outside and through the vehicle floor and is resistant to warming from heated air being pushed down from above. Thus during cold weather, and during extended trips, even though the upper cabin may be comfortable, occupants often have chilled feet. While passengers may lift their feet up and onto the seats in order to warm their feet away from the floor, this option is not available to the driver.

Efforts are being looked at to provide heat directly to the vehicle occupants without heating the entire interior and without blowing warmed air about the cabin. These focused heat efforts include heated seats in most electric vehicles because it is more efficient to heat the passenger directly. In fact certain electric vehicle manuals have instructions to use the heated seats rather than the central heater in order to preserve electric mileage range. Other research efforts are looking at radiant panels placed in strategic locations in the vehicle body such as the footwell, side door or instrument panel to provide radiant heat directed to the occupants. However, none of these have yet to reach the market place.

The problem with past heating efforts for vehicle interiors is that they do not make efficient use of electricity to warm the feet. Electric floor mats are also known that plug into the power outlet but these floor mats produce much heat that permeate to the cabin away from the occupant. These floor mats have been developed with electric wires passing through substantially the entire mat of which most of the area is not placed directly under the feet. However, if one looks at well-worn mats from many vehicles, one may notice that most of the wear is at one or two areas where the occupant most likely placed the right and left foot. The rest of the mat shows much less wear because the feet are rarely placed there or placed there for only short periods of time.

A driver of a vehicle also has his/her foot on the accelerator pedal a significant amount of time. The foot is often on the pedal even when coasting and not pushing down on the pedal. The left foot is often resting on a footrest that may be elevated relative to the rest of the footwell floor surface. Other passengers in the vehicle place their feet in particular locations in the footwell, whether in the front passenger seat or in the rear seats. Efficient use of heat energy directs one to not place radiant panels remote from the occupant or heat the entire floor mat or floor to adequately warm an occupant, particularly an occupant's feet.

What is needed is an improved and efficient focused heating system to directly warm the right foot and optionally the left foot of an occupant in an electric or other vehicle when the feet are on the accelerator pedal and the footrest or certain areas of the floor particularly during longer trips. What is also needed is radiant heat system which provides a greater concentration of heat on areas of the floor in a vehicle where the feet are most likely to be. Particular efforts need to be made to warm the feet which will give the occupant a perception and feeling of warmth.

### SUMMARY OF THE DISCLOSURE

In accordance with one aspect of the invention, an electrically powered heating system for a vehicle has a footrest built into a footwell of a vehicle having a structural substrate for supporting a driver's foot and an upper surface. A heating element is embedded in the footrest between the upper surface and the structural substrate for heating the footrest. The heating element has electric leads that are operably connectable to an electric power source for providing power to the heating element for producing heat.

In one embodiment, the heating element is electrically resistive to produce heat and is in the form of a convoluting wire covering a substantial area under the upper surface of the footrest. In another embodiment, the heating element being a radiant panel. It is preferable that an insulating layer is interposed between the heating element and the structural substrate.

In one embodiment, the heating system includes an accelerator pedal having an upper surface constructed for engagement with a driver's driving foot e.g. a right foot. A heating element is embedded in the accelerator pedal below the upper surface for heating the accelerator pedal. The heating element has electric leads that are operably connectable to an electric power source for providing power to the heating element for producing heat in the accelerator pedal.

It is also preferable to have a designated area in a floor covering in the footwell with a heating element under the surface for heating. One or more designated areas are sized to be approximately the size of a human foot and generally in a foot shape. It is preferable that the designated areas are visually distinctive from the rest of the floor covering.

Preferably any floor mat placed on the floor is shaped with a cut-out section for exposing one or more designated areas. One designated area for the right driver's foot may be activated with activation of a cruise control system for the vehicle.

In accordance with another embodiment of the invention, a floor covering in a footwell covers a floor of a vehicle and a designated area in the floor covering has a heating element under the surface for heating. The designated area is sized to be approximately the size of a human foot and the designated area is constructed to produce more dense heat energy than any floor area outside of the designated area. The designated area is generally in a foot shape. The designated area is preferably visually distinctive from the rest of the floor covering. In one embodiment, the floor covering is in the form of a removable mat.

According to another aspect of the invention, an accelerator pedal has an upper surface constructed for engagement with a driver's foot and a structural substrate below the upper surface. A heating element is embedded in the accelerator pedal below the upper surface for heating the accelerator pedal. The heating element has electric leads that are operably connectable to an electric power source for providing power to the heating element for producing heat. Preferably, the heating element is electrically resistive to produce heat. The heating element is in the form of a convoluting wire covering a substantial area under the upper surface of the accelerator pedal. In another embodiment, the heating element is in the form of a radiant panel. Preferably, an insulating layer is interposed between the heating element and the structural substrate.

### BRIEF DESCRIPTION OF THE DRAWINGS

Reference now is made to the accompanying drawings in which:

FIG. 1 is a perspective view of a vehicle driver's footwell in an vehicle incorporating an embodiment of the invention;

FIG. 2 is an exploded perspective view of the accelerator pedal shown in FIG. 1;

FIG. 3 is a cross sectional view of the accelerator pedal taken along line 3-3 as shown in FIG. 1;

FIG. 4 is a fragmentary perspective and segmented view of an alternative embodiment of the accelerator pedal;

FIG. 5 is an exploded fragmentary and segmented view of another embodiment of an accelerator pedal according to the invention;

FIG. 6 is a top plan view of a mat juxtaposed in position with designated area in the footwell shown in FIG. 1;

FIG. 7 is an alternate embodiment of a mat; and

FIG. 8 is another embodiment in the form of a mat according to the invention.

### DETAILED DESCRIPTION OF THE PREFERRED EMBODIMENT

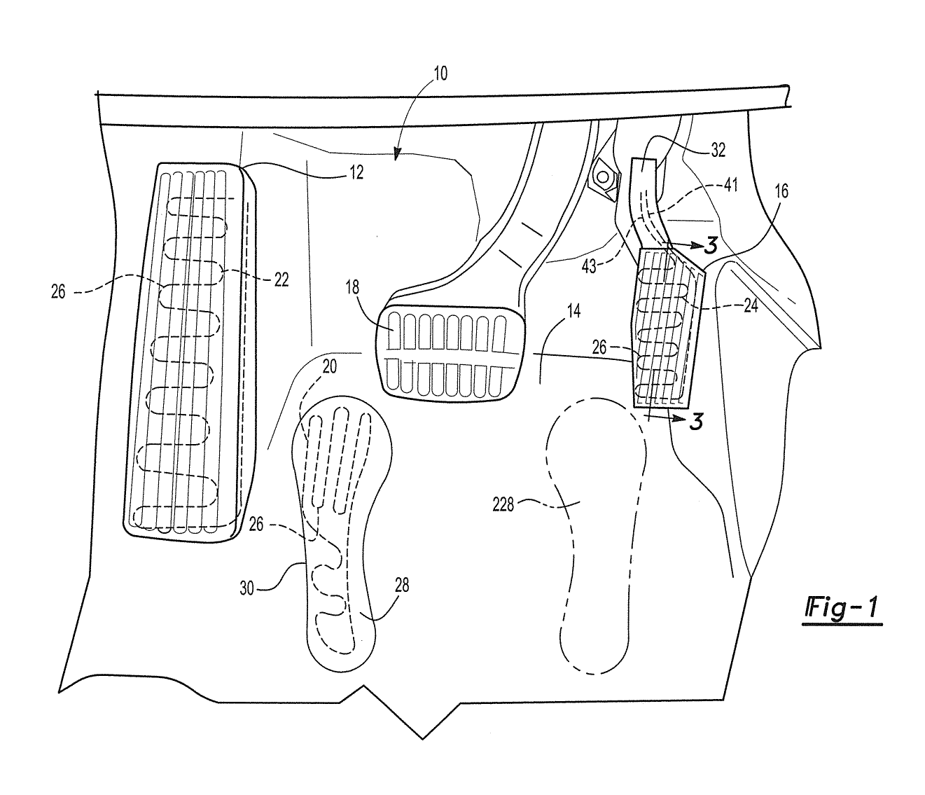

Referring now to FIG. 1, a footwell 10 for a vehicle has a footrest 12 and floor 14. If the footwell 10 is for a driver, it also includes an accelerator pedal 16 and brake pedal 18.

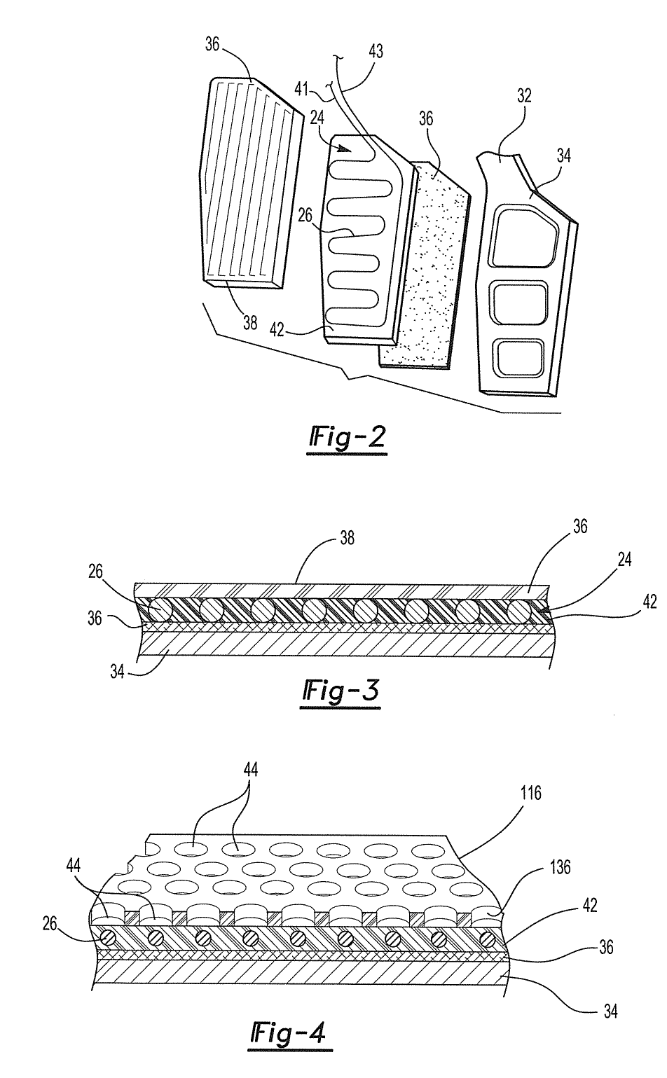

Heating elements 20, 22, and 24 are installed in the floor 14, the footrest 12 and in the accelerator pedal 16 respectively. Each heating element 20, 22, and 24 is a resistive electric wire 26 installed in a convoluting manner, for example sinusoidally, in the footrest 12, designated area 28 of the floor 14 and in the accelerator pedal 16. The shape of the designated area 28 is generally in the shape of a left shoe bottom or left foot as shown in FIG. 2. For purposes of this invention, the terms “foot” or “foot shape” can be broad enough to encompass shoes, boots, sandals and other footwear that is worn on a person's foot as well as a person's bare foot.

Furthermore, the designated area 28 may be visually distinctive from the rest of the floor to provide an intuitive indication 30 that this designated area 28 of the floor 14 is heated. Such visual indication 30 may for example be a different color, a shorter carpet pile than the rest of floor 14 or other indication such as stripes or other patterns such as wiggly heat lines.

Heating elements 20, 22, and 24 are installed in the footrest 12, floor 14 and accelerator pedal 16 in similar fashions so details will be described only for the heating element 24 in the accelerator pedal 16 while referring to FIGS. 2 and 3 in order to avoid redundancy. The accelerator pedal 16 has an operable pivot frame 32 connected to the vehicle to suspend a structural substrate 34 that is strong enough to be repeatedly pressed by a driver's foot. An insulating layer 36 is laid on the structural substrate 34 and a heating element 24 is laid on the insulating layer. The insulating layer 36 may have a reflective upper surface to promote heat that is initially radiated downwardly to be redirected back upwards to the feet. A cover 36 with an upper surface 38 is then installed on the accelerator pedal 16 to conceal the heating element but still allowing heat to be transferred through the cover. As better shown in FIG. 3, the wire 26 of the heating element 24 may be embedded in an elastomeric layer 42 to ease installation. The wire has two leads 41 and 43 that may be installed along the pivot frame 32 to be connected to operable power source and switch controls (not shown).

Another embodiment of the accelerator pedal 116 is shown in FIG. 6 which further allows heat to be transferred through apertures 44 through cover 136. The heating element 24 is laid under the upper surface 138 of the rubber cover 136. The wires 26 of the heating element are aligned directly under the apertures 44 to enhance heat transfer upwardly. The apertures 44 may be circular in shape as shown or alternatively slotted in shape. Other shapes may also be suitable.

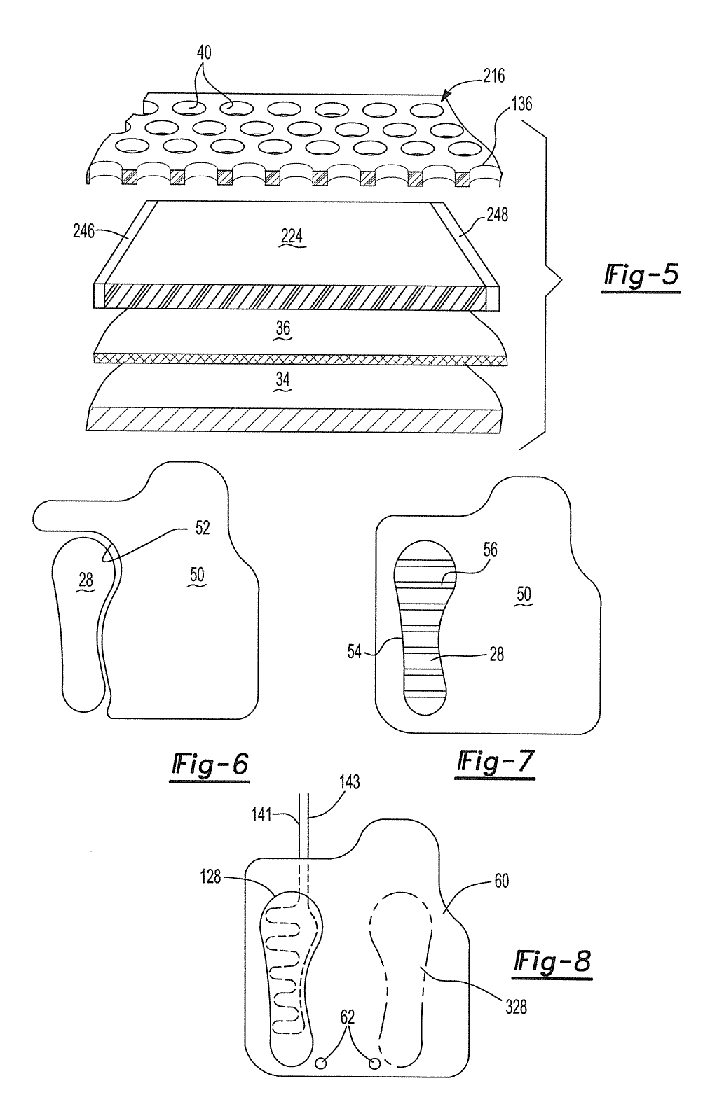

An alternate embodiment 216 is shown in FIG. 5 where the resistive wire 26 in the heating element 24 is substituted with a radiant panel 226 under the cover 136. The radiant panel 226 has a positive terminal 246 and negative terminal 248 at opposite ends. The entire panel 224 is conductive or semi-conductive and creates heat in an approximately uniform manner.

If a mat 50 is desired to be placed on the floor 14 of the footwell 10, the mat 50 as shown in FIG. 6 can have a modified shape with a cutout 52 to accommodate the designated area 28 to have more direct exposure to the left foot of the occupant. Alternatively the cutout may be in the form of a complete aperture 54 with reinforcing straps 56 to maintain the shape of the mat 50 while promoting heat transfer from the designated area 28 to the occupant's foot as shown in FIG. 7.

In certain vehicles, a mat 60 as shown in FIG. 8 may be a more permanent part of vehicle and may even have a fastener system 62 for locking or securing to the vehicle floor 14. In this situation, it may be desirable to place a heated designated area 128 in the mat instead of the floor 14. The designated area 128 is similar in shape to the designated area 28 and is placed in the mat 60 such that when the mat is installed, the designated area 128 is suitably placed to heat the left foot of the occupant when the occupant takes his foot off the footrest 12 and places it on the floor 14. The mat has electrical leads 141 and 143 which may be in a common chord with an electrical connector not shown that can connect to a pig lead with a complementary connector in the footwell to connect to the switching controls and power source.

In certain upscale and most luxury vehicles, the vehicle is equipped with cruise control which allows the driver to remove the right foot from the accelerator pedal 16 for extended periods of time particularly during longer rides on relatively empty roads or expressways. For the cruise controlled equipped vehicles, it may also be desirable to have additional designated areas 228 and 328 shown in phantom on the floor 14 or mat 60 in the driver's footwell respectively to heat the right foot when it is removed from the accelerator pedal 16 and placed on the floor 14 or mat 60. These areas 228 and 328 are constructed in the same fashion as areas 28 and 128 except that the shape is for the right foot. The designated areas 228 and 328 are also suitable for passenger footwells where a passenger normally has both the left and right foot on the floor.

Control of the heating elements 20, 22 and 24 may be tied into the circuit with the heated seats and have an appropriate thermal switch to maximize comfort and prevent overheating and/or discomfort. The heating elements may have a separate switch conveniently located for example on the instrument panel. For most flexibility and most efficient use of the heater elements, each seat may have its own control switch. If there is a separate switch, it may also have heat levels in much the same fashion as used for heated seats. Suitable temperatures may be 105° F. for a low setting and may be as high as 120° F. for timed out cycles for example ten minutes. Thus, the heated elements may be tied to an electric circuit that has a timer control, for example, similar to one used for electric rear defrosters. In addition, areas 228 and 328 in the driver's footwell may be usually turned off and tied into the cruise control of the vehicle and activated when the cruise control is activated.

The heater element 24 in the accelerator is suitable for different styles of pedals. Certain pedals are pivotably mounted at a lower joint and extend upward. They are sized to cover substantially the entire length of the foot. Other pedals as shown are suspended from an operable hinge or pivot frame 32 above the pedal. These pedals are usually smaller in size and are usually positioned to be adjacent the distal end of the foot i.e. to be operated by the toe end of the foot. Heat provided to the distal end of the foot will efficiently warm the toes and the rest of the foot. In this fashion, radiant electric heat is efficiently delivered to areas that are directly under an occupant's feet. In this manner, wasted energy to empty areas of the vehicle cabin and areas not directly under a foot are greatly reduced.

In certain applications, radiant heat may still be delivered to other areas of the footwell 10 particularly the floor. In these situations where the entire footwell is heated, there will be higher density of heat energy delivered to designated areas 28, 128, 228 and 328 than to other areas of the floor.

Other variations and modifications are possible without departing from the scope and spirit of the present invention as defined by the appended claims.

The embodiments in which an exclusive property or privilege is claimed are defined as follows:

1. An accelerator pedal for a motor vehicle comprising:
an upper surface constructed for engagement with a driver's foot;
a structural substrate below said upper surface;
a heating element embedded in the accelerator pedal below the upper surface for heating the accelerator pedal; and
said heating element having electric leads that are operably connectable to an electric power source for providing power to said heating element for producing heat.

2. An accelerator pedal as defined in claim 1 further comprising:
said heating element being electrically resistive to produce heat.

3. An accelerator pedal as defined in claim 2 further comprising:
said heating element being in the form of a convoluting wire covering a substantial area under said upper surface of said accelerator pedal.

4. An accelerator pedal as defined in claim 1 further comprising:
said heating element being a radiant panel.

5. An accelerator pedal as defined in claim 1 further comprising:
an insulating layer interposed between said heating element and said structural substrate.

6. An electrically powered heating system for a vehicle, said system comprising:
a footrest built into a footwell of a vehicle having a structural substrate;
an upper surface of said footrest constructed for engagement with a driver's foot;
a heating element embedded in the footrest between said upper surface and said substrate for heating the footrest; and
said heating element having electric leads that are operably connectable to an electric power source for providing power to said heating element for producing heat.

7. An electrically powered heating system for a vehicle as defined in claim 6 further comprising:
said heating element being electrically resistive to produce heat.

8. An electrically powered heating system for a vehicle as defined in claim 7 further comprising:
said heating element being in the form of a convoluting wire covering a substantial area under said upper surface of said footrest.

9. An electrically powered heating system for a vehicle as defined in claim 6 further comprising:
said heating element being a radiant panel.

10. An electrically powered heating system for a vehicle as defined in claim 6 further comprising:
an insulating layer interposed between said heating element and said structural substrate.

11. An electrically powered heating system for a vehicle as defined in claim 6 further comprising:
an accelerator pedal having an upper surface constructed for engagement with a driver's other foot;
a heating element embedded in the accelerator pedal below the upper surface for heating the accelerator pedal; and
said heating element having electric leads that are operably connectable to an electric power source for providing power to said heating element for producing heat.

12. An electrically powered heating system for a vehicle as defined in claim 11 further comprising:
a floor covering in said footwell covering a floor of said vehicle and a designated area on said floor that has a heating element under said surface for heating; and
said designated area being sized to be approximately the size of a human foot.

13. An electrically powered heating system for a vehicle as defined in claim 12 further comprising:
said designated area being generally in a foot shape.

14. An electrically powered heating system for a vehicle as defined in claim 12 further comprising:
said designated area being visually distinctive from the rest of said floor covering.

15. An electrically powered heating system for a vehicle as defined in claim 12 further comprising:
a floor mat placed on said floor covering and having a cut-out section for exposing said designated area.

16. An electrically powered heating system for a vehicle as defined in claim 12 further comprising:
said heating element in said designated area being activated with activation of a cruise control system for said vehicle.

17. An electrically powered heating system for a vehicle, said system comprising:
a floor covering in said footwell covering a floor of said vehicle and a designated area of said floor covering under its upper surface having a heating element for heating; and
said designated area being sized to be approximately the size of a human foot and said designated area being delivered more heating energy density than floor areas outside of said designated area.

18. An electrically powered heating system for a vehicle as defined in claim 17 further comprising:
said designated area being generally in a foot shape.

19. An electrically powered heating system for a vehicle as defined in claim 17 further comprising:
said designated area being visually distinctive from the rest of said floor covering.

20. An electrically powered heating system for a vehicle as defined in claim 17 further comprising:
said floor covering being a removable mat.
